(19) United States
(12) Patent Application Publication
(10) Pub. No.: US 2026/0046906 A1
(43) Pub. Date: Feb. 12, 2026

(54) METHOD AND APPARATUS FOR A RESOURCE RE-EVALUATION OR PRE-EMPTION CHECKING PROCEDURE

(71) Applicant: Lenovo (Beijing) Limited, Beijing (CN)

(72) Inventors: Xiaodong Yu, Beijing (CN); Zhennian Sun, Beijing (CN); Haipeng Lei, Beijing (CN); Xin Guo, Beijing (CN); Yu Zhang, Beijing (CN)

(73) Assignee: Lenovo (Beijing) Limited, Beijing (CN)

(21) Appl. No.: 18/998,895

(22) PCT Filed: Aug. 3, 2022
(86) PCT No.: PCT/CN2022/109908

§ 371 Date: Jan. 27, 2025

(51) Int. Cl. H04W 72/40; H04W 16/14; H04W 72/50

(52) U.S. Cl. CPC H04W 72/40; H04W 16/14; H04W 72/535

(57) ABSTRACT

Embodiments of the present disclosure relate to methods and apparatuses of a channel occupancy time (COT) sharing mechanism for a sidelink groupcast. According to some embodiments of the disclosure, a user equipment (UE) may include a transceiver; and a processor coupled to the transceiver. The processor may be configured to: perform a resource re-evaluation procedure or a pre-emption checking procedure to determine whether a candidate resource within a set of candidate resources for the UE is available, wherein the candidate resource is selected or reserved by the UE for a sidelink transmission on an unlicensed spectrum; and in response to determining that the candidate resource is unavailable, exclude the candidate resource from the set of candidate resources.

### TECHNICAL FIELD

Embodiments of the present disclosure generally relate to wireless communication technology, and more particularly to a method and apparatus for a resource re-evaluation or pre-emption checking procedure.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmission may be performed on a licensed spectrum and an unlicensed spectrum.

There is a need for providing a resource re-evaluation or pre-emption checking procedure for a sidelink unlicensed (SL-U) spectrum.

### SUMMARY

Some embodiments of the present disclosure provide a user equipment (UE). The UE may include: a transceiver; and a processor coupled to the transceiver. The processor may be configured to: perform a resource re-evaluation procedure or a pre-emption checking procedure to determine whether a candidate resource within a set of candidate resources for the UE is available, wherein the candidate resource is selected or reserved by the UE for a first sidelink transmission on an unlicensed spectrum; and in response to determining that the candidate resource is unavailable, exclude the candidate resource from the set of candidate resources.

In some embodiments, the processor of the UE is configured to receive first information or determine the first information, wherein the first information includes at least one of: a first indication for indicating a resource reservation period; a second indication for indicating a priority level; a third indication for indicating a channel access priority class (CAPC) value; a fourth indication for indicating a total number of resources in a time domain within a listen-before-talk (LBT) sensing duration; a fifth indication for indicating a mapping relationship between the CAPC value and a time length of the LBT sensing duration; or a sixth indication for enabling or disabling a channel occupancy time (COT) sharing behaviour of the UE.

In some embodiments, in response to receiving the first information, the first information is included in at least one of: at least one of sidelink control information (SCI) or a second sidelink transmission received via the transceiver on a first resource before the candidate resource in the time domain; or configuration information received via the transceiver from a network node; configuration information per a resource pool received via the transceiver from the network node; or indication information received from an upper layer of the UE.

In some embodiments, the processor of the UE is configured to perform at least one of: determining a reserved resource for an assumed sidelink transmission to be received by the UE from a second UE based on the first indication; in response to determining that the reserved resource is after the candidate resource in the time domain, determining a first LBT sensing duration before the reserved resource based on at least one of: the second indication, the third indication, the fourth indication, or the fifth indication; or in response to determining that the reserved resource is before the candidate resource in the time domain, determining a second LBT sensing duration before the candidate resource based on at least one of: the second indication, the third indication, the fourth indication, or the fifth indication.

In some embodiments, the reserved resource is determined based on the first resource and the resource reservation period indicated by the first indication.

In some embodiments, to determine whether the candidate resource is available, the processor of the UE is configured to perform at least one of: determining whether a first set of time-frequency resources within the candidate resource overlaps with a second set of time-frequency resources within the reserved resource; in response to determining that the reserved resource is after the candidate resource in the time domain, determining whether the first set is located within the first LBT sensing duration before the reserved resource; in response to determining that the reserved resource is before the candidate resource in the time domain, determining whether the second set is located within the second LBT sensing duration before the candidate resource; or determining whether a priority level of the reserved resource is higher than a priority level of the candidate resource.

In some embodiments, the processor of the UE is configured to determine that the candidate resource is unavailable in response to determining one of: the first set overlaps with the second set; the first set is located within the first LBT sensing duration; the first set is located within the first LBT sensing duration, and the priority level of the reserved resource is higher than the priority level of the candidate resource; the second set is located within the second LBT sensing duration; or the second set is located within the second LBT sensing duration, and the priority level of the reserved resource is higher than the priority level of the candidate resource.

In some embodiments, the processor of the UE is configured to determine that the candidate resource is available in response to determining one of: the first set does not overlap with the second set; the first set is not located within the first LBT sensing duration; the first set is located within the first LBT sensing duration, and the priority level of the reserved resource is lower than the priority level of the candidate resource; the second set is not located within the second LBT sensing duration; or the second set is located within the second LBT sensing duration, and the priority level of the reserved resource is lower than the priority level of the candidate resource.

In some embodiments, in response to determining that the first set is located within the first LBT sensing duration, the processor of the UE is configured to: determine whether one or more time-frequency resources within the first set for transmitting the first sidelink transmission overlap with the first LBT sensing duration; in response to determining that the one or more frequency time resources overlap with the first LBT sensing duration, determine that the candidate resource is unavailable; or in response to determining that the one or more frequency time resources do not overlap with the first LBT sensing duration, determine that the candidate resource is available.

In some embodiments, in response to determining that the first set is located within the first LBT sensing duration, the processor of the UE is configured to: determine whether a first COT including the candidate resource initialized by the UE can be shared to the assumed sidelink transmission in the reserved resource; or in response to determining that the first COT cannot be shared to the assumed sidelink transmission in the reserved resource, determine that the candidate resource is unavailable.

In some embodiments, the processor of the UE is configured to: determine whether the sixth indication enables or disables the COT sharing behaviour of the UE; and in response to determining that the sixth indication enables the COT sharing behaviour of the UE, start to determine whether the first COT can be shared to the assumed sidelink transmission in the reserved resource.

In some embodiments, in response to determining that the first COT can be shared to the assumed sidelink transmission in the reserved resource, the processor of the UE is configured to perform one of: determining that the candidate resource is available; or transmit, to an upper layer of the UE, at least one of a re-evaluation or pre-emption checking result for the candidate resource or information associated with the first COT, wherein the upper layer of the UE is configured to determine whether the candidate resource is available based on the at least one of the re-evaluation or pre-emption checking result for the candidate resource or the information associated with the first COT.

In some embodiments, the information associated with the first COT includes at least one of: remaining channel occupancy duration of the first COT; CAPC information of the first COT; or priority level information of the first COT.

In some embodiments, in response to determining that the second set is located within the second LBT sensing duration, the processor of the UE is configured to: determine whether a second COT including the reserved resource initialized by the second UE can be shared to the first sidelink transmission in the candidate resource; or in response to determining that the second COT cannot be shared to the first sidelink transmission in the candidate resource, determine that the candidate resource is unavailable.

In some embodiments, in response to determining that the second COT can be shared to the first sidelink transmission in the candidate resource, the processor of the UE is configured to perform one of: determining that the candidate resource is available; transmitting, to an upper layer of the UE, at least one of a re-evaluation or pre-emption checking result for the candidate resource or information associated with the second COT, wherein the upper layer of the UE is configured to determine whether the candidate resource is available based on the at least one of the re-evaluation or pre-emption checking result for the candidate resource or the information associated with the second COT; or transmitting, to the upper layer of the UE, a preferred type of an LBT procedure before the candidate resource performed by the UE.

In some embodiments, the information associated with the second COT includes at least one of: remaining channel occupancy duration of the second COT; CAPC information of the second COT; or priority level information of the second COT.

Some embodiments of the present disclosure provide a network node (e.g., a BS). The network node may include: a transceiver; and a processor coupled to the transceiver. The processor may be configured to: transmit configuration information per a resource pool via the transceiver to a user equipment (UE), wherein the configuration information includes at least one of: an indication for indicating a channel access priority class (CAPC) value associated with the UE; an indication for indicating a total number of resources in a time domain within a listen-before-talk (LBT) sensing duration associated with the UE; an indication for indicating a mapping relationship between the CAPC value and a time length of the LBT sensing duration; or an indication for enabling or disabling a channel occupancy time (COT) sharing behaviour of the UE.

Some embodiments of the present disclosure provide a method for wireless communication performed by a UE. The method may include: performing a resource re-evaluation procedure or a pre-emption checking procedure to determine whether a candidate resource within a set of candidate resources for the UE is available, wherein the candidate resource is selected or reserved by the UE for a first sidelink transmission on an unlicensed spectrum; and in response to determining that the candidate resource is unavailable, excluding the candidate resource from the set of candidate resources.

Some embodiments of the present disclosure provide a method for wireless communication performed by a network node (e.g., a BS). The method may include: transmit configuration information per a resource pool to a user equipment (UE), wherein the configuration information includes at least one of: an indication for indicating a channel access priority class (CAPC) value associated with the UE; an indication for indicating a total number of resources in a time domain within a listen-before-talk (LBT) sensing duration associated with the UE; an indication for indicating a mapping relationship between the CAPC value and a time length of the LBT sensing duration; or an indication for enabling or disabling a channel occupancy time (COT) sharing behaviour of the UE.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure.

FIG. 2A illustrates an exemplary resource re-evaluation procedure in accordance with some embodiments of the present disclosure.

FIG. 2B illustrates an exemplary pre-emption checking procedure in accordance with some embodiments of the present disclosure.

FIG. 3 illustrates an exemplary flowchart of performing a resource re-evaluation procedure or a pre-emption checking procedure in accordance with some embodiments of the present disclosure.

FIGS. 4, 5A, and 5B illustrate schematic diagrams of a resource re-evaluation procedure in accordance with some embodiments of the present disclosure.

FIGS. 6A and 6B illustrate schematic diagrams of sharing a COT during a resource re-evaluation procedure in accordance with some embodiments of the present disclosure.

FIG. 7 illustrates a schematic diagram of a resource re-evaluation procedure in accordance with some embodiments of the present disclosure.

FIGS. 8A and 8B illustrate schematic diagrams of sharing a COT during a resource re-evaluation procedure in accordance with some embodiments of the present disclosure.

FIG. 9 illustrates a schematic diagram of a pre-emption checking procedure in accordance with some embodiments of the present disclosure.

FIGS. 10A and 10B illustrate schematic diagrams of sharing a COT during a pre-emption checking procedure in accordance with some embodiments of the present disclosure.

FIG. 11 illustrates a schematic diagram of a pre-emption checking procedure in accordance with some embodiments of the present disclosure.

FIGS. 12A and 12B illustrate schematic diagrams of sharing a COT during a pre-emption checking procedure in accordance with some embodiments of the present disclosure.

FIG. 13 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

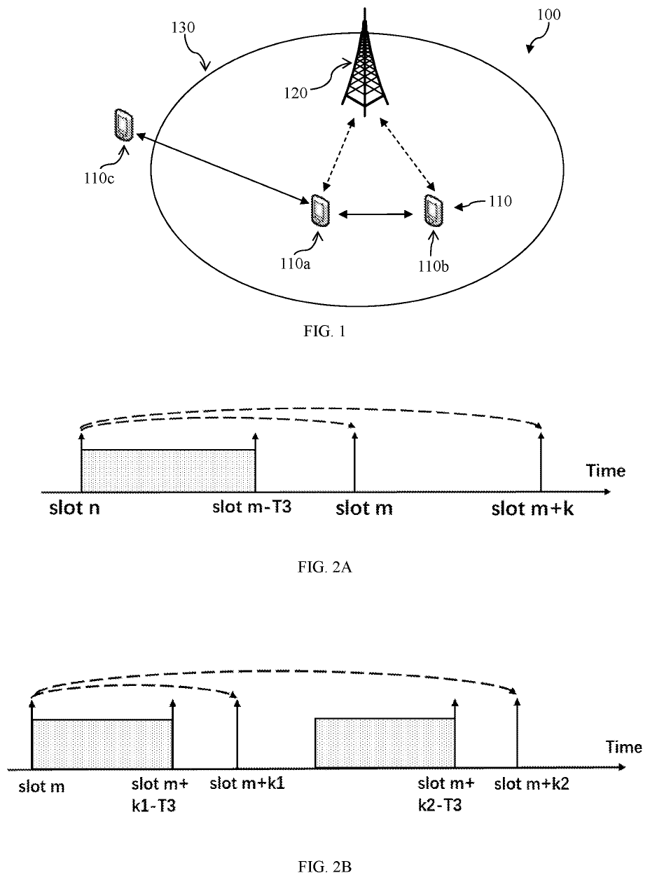

FIG. 1 illustrates a schematic diagram of a wireless communication system 100 in accordance with some embodiments of the present disclosure.

As shown in FIG. 1, a wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 1302.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1).

Sidelink transmission may involve a physical sidelink control channel (PSCCH) and an associated physical sidelink shared channel (PSSCH), which may be scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

In some embodiments of the present disclosure, sidelink transmission may be performed on an unlicensed spectrum. When an unlicensed spectrum is used for sidelink transmissions, a channel access procedure (also known as a listen-before-talk (LBT) test or LBT procedure) is required before any sidelink transmission. Two types of channel access procedures, i.e., LBT type 1 and LBT type 2 are supported.

In general, a COT sharing mechanism may be defined on a DL or a UL. In sidelink (SL) communication mode 2, a COT initiator UE may initialize a COT based on its traffic and the traffic priority (CAPC), and the COT size (time duration) is associated with CAPC value. If the COT initiator UE only uses a part of the COT, the remaining part of the COT can be shared to another UE, i.e., a COT shared UE. In addition, based on the regulation, the destination UE of a COT shared UE should be a COT initiator UE. A COT initiator UE may indicate COT related information in SCI, e.g., the remaining channel occupancy duration of the COT similar as Uu link DCI. The COT shared UE may determine whether to be shared the COT based on the SCI, which includes the remaining channel occupancy duration of the COT and ID information.

Currently, a resource re-evaluation procedure and a pre-emption checking procedure are supported in NR SL communication. After a resource is selected for PSCCH and/or PSSCH transmission(s) by higher layer(s) of a UE, the higher layer(s) of the UE may request the UE to perform re-evaluation or pre-emption on a set of resources, e.g., (r₀, r₁, r₂, . . . ) or

$$( {r}_{0}^{′} , {r}_{1}^{′} , {r}_{2}^{′} , … ) .$$

Then, the UE shall report the re-evaluation or pre-emption result(s). For example, if the higher layer(s) of the UE requests the UE to determine a subset of candidate resources from which the higher layer(s) will select resource(s) for PSSCH and/or PSCCH transmission(s) as a part of the re-evaluation or pre-emption checking procedure, the higher layer(s) may provide a set of resources, e.g., (r₀, r₁, r₂, . . . ) which may be subject to re-evaluation and a set of resources, e.g.

$$( {r}_{0}^{′} , {r}_{1}^{′} , {r}_{2}^{′} , … )$$

which may be subject to pre-emption. For example, if resource rᵢ from the set (r₀, r₁, r₂, . . . ) is not a member of a set of candidate resources, e.g., S_{A}, the UE shall report re-evaluation result(s) of resource rᵢ to higher layer(s). If resource

$${r}_{i}^{′}$$

from the set

$$( {r}_{0}^{′} , {r}_{1}^{′} , {r}_{2}^{′} , … )$$

meets certain condition(s), the UE shall report pre-emption result(s) of the resource

$${r}_{i}^{′}$$

to higher layer(s).

In the embodiments of the present disclosure, higher layer(s) of a UE and upper layer(s) of the UE may be used interchangeably, a time slot and a slot may be used interchangeably, a sensing window and a sensing duration may be used interchangeably, and “a frequency and/or time resource” and “a time-frequency resource” may be used interchangeably, when appropriate. In the embodiments of the present disclosure, T3 represents a UE's processing time and may be marked as “T” or the like.

FIG. 2A illustrates an exemplary resource re-evaluation procedure in accordance with some embodiments of the present disclosure. In the embodiments of FIG. 2A, a UE may perform a resource selection at slot n in time domain, and the selected resources are allocated at slot m and slot m+k. The resource re-evaluation procedure for the selected resources may be performed, at least, at slot m−T3. It can be based sensing result(s) from the sensing window, e.g., between slot n and slot m−T3.

In some embodiments, if a reservation indication (e.g., transmitted from another UE) is detected within the sensing window corresponding to the selected resource at slot m, and if the selected resource, e.g., resource rᵢ from the set (r₀, r₁, r₂, . . . ), is not a member of a set of candidate resources, e.g., S_{A}, the UE may report re-evaluation result(s) of resource rᵢ to higher layer(s). It is up to the UE's implementation to re-evaluate “before slot m−T3” or “after slot m−T3 but before slot m”.

FIG. 2B illustrates an exemplary pre-emption checking procedure in accordance with some embodiments of the present disclosure. In the embodiments of FIG. 2B, a UE may perform a SL transmission on a selected resource at slot m and indicates reserved resources at slot m+k1 and slot m+k2. The resource pre-emption checking for the reserved resources may be performed, at least, at slot m+k1-T3 and slot m+k2−T3. It can be based the sensing result(s) from sensing windows, e.g., “between slot m and slot m+k1−T3” and “between slot m+k1 and slot m+k2−T3”.

In some embodiments, if a reservation indication and a priority level indication (e.g., transmitted from another UE) are detected within the sensing window corresponding to the reserved resource at slot m+k1 (e.g.,

$${r}_{i}^{′}$$

from the set

$$( {r}_{0}^{′} , {r}_{1}^{′} , {r}_{2}^{′} , … ) )$$

and the resource indicated by the reserved indication is (partial) overlapped with the reserved resource, and the priority level of the another UE is higher than the priority level of the UE, the UE may determine that the reserved resource, e.g.,

$${r}_{i}^{′} ,$$

is not a member of S_{A}. Then, the UE may report pre-emption result(s) of resource

$${r}_{i}^{′}$$

to higher layer(s). It is up to the UE's implementation to pre-empt “before slot m+k1−T3” or “after slot m+k1−T3 but before slot m+k1”.

In general, the legacy resource re-evaluation or pre-emption checking procedure only considers avoiding the resource collision (resource overlapping or partial overlapping) on selected or reserved resource(s). For SL-U, before the transmission on the selected or reserved resource(s), an LBT operation should be performed. If a potential transmission is detected within the LBT sensing duration of a UE, the UE may not access the channel for SL transmission, and the selected or reserved resource(s) will not be used; or, if the transmission on the selected or reserved resource(s) within another UE's LBT sensing duration, it will have impact on the channel access of the another UE and its transmission, even if there is no resource collision (resource overlapping or partial overlapping) on the selected or reserved resource(s) between the UE and the another UE.

Currently, there is a need to enhance a resource re-evaluation procedure and/or a pre-emption checking procedure with considering the potential transmission impact on an LBT operation. Embodiments of the present disclosure provide solutions aim to solve the above issue. For example, some embodiments of the present disclosure define resource re-evaluation and pre-emption checking mechanisms or steps for SL-U. Some embodiments of the present disclosure define an indicator to enable or disable a COT sharing behaviour of a UE during resource re-evaluation and pre-emption checking mechanisms or steps.

More details on the embodiments of the present disclosure will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

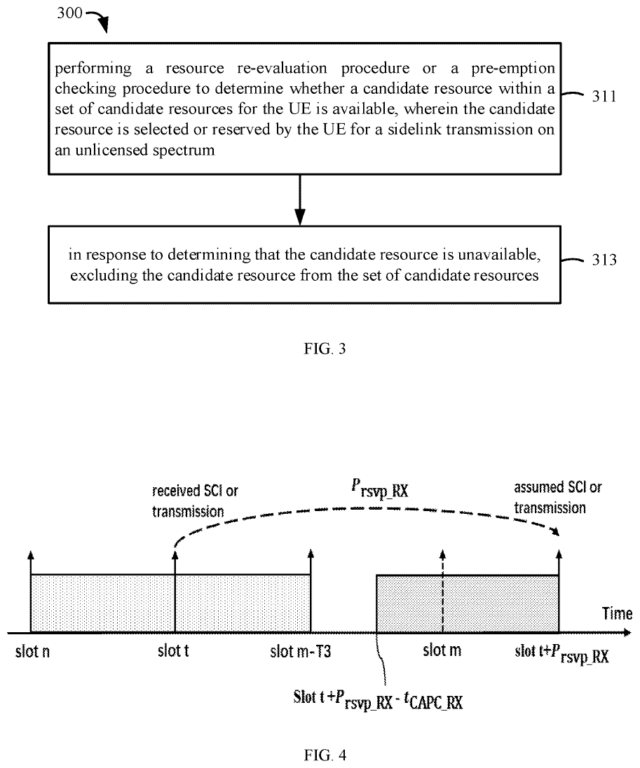

FIG. 3 illustrates an exemplary flowchart 300 of performing a resource re-evaluation procedure or a pre-emption checking procedure in accordance with some embodiments of the present disclosure. The exemplary flowchart 300 may be performed by a UE. Although described with respect to a UE, it should be understood that other devices may be configured to perform a similar procedure. Details described in all of other embodiments of the present disclosure are applicable for the embodiments shown in FIG. 3.

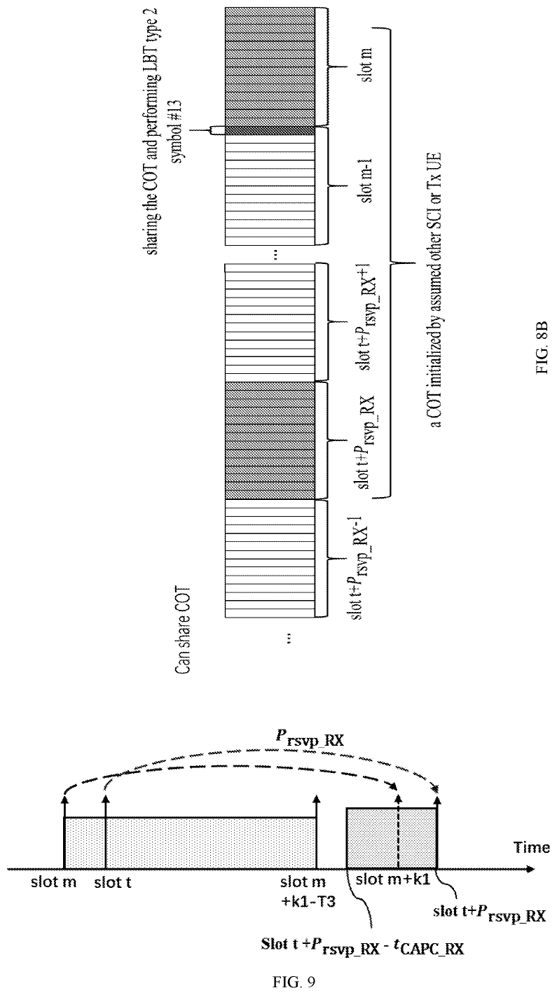

In the exemplary flowchart 300, in operation 311, a UE (e.g., UE 110a in FIG. 1) may perform a resource re-evaluation procedure or a pre-emption checking procedure to determine whether a candidate resource within a set of candidate resources for the UE is available. The candidate resource may be selected or reserved by the UE for a sidelink transmission (denoted as sidelink transmission #1 for simplicity) on an unlicensed spectrum. For example, the candidate resource may refer to “slot m” in the embodiments of any of FIGS. 4-8B or “slot m+k1” in the embodiments of any of FIGS. 9-12B. The set of candidate resources may refer to S_{A} in the embodiments of any of FIGS. 4-12B. Sidelink transmission #1 may be a PSCCH and/or PSSCH transmission.

In operation 313, in response to determining that the candidate resource is unavailable, the UE may exclude the candidate resource from the set of candidate resources.

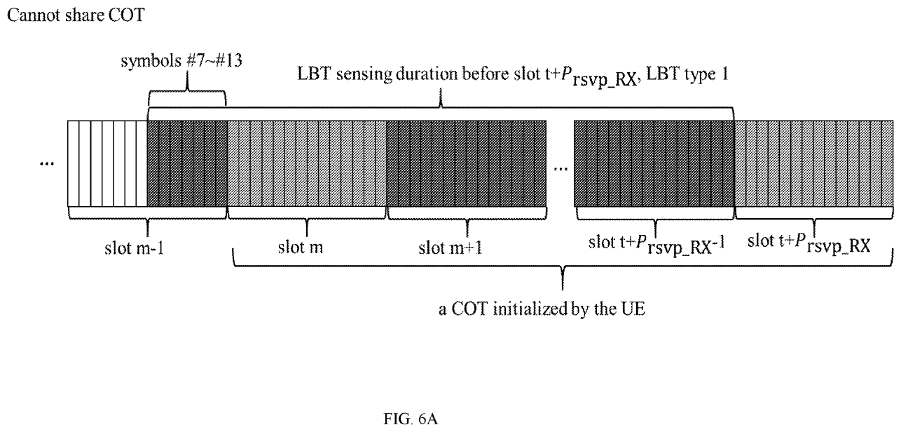

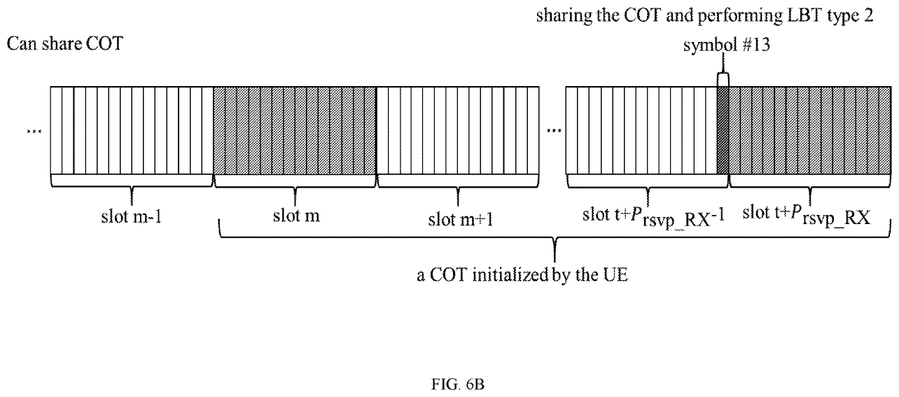

In some embodiments, the UE may receive information (denoted as information #1 for simplicity) or determine information #1. Information #1 may include at least one of:
(1) An indication (denoted as indication #1) for indicating a resource reservation period (e.g., P_{rsvp_RX}).
(2) An indication (denoted as indication #2) for indicating a priority level, e.g., a priority indication.
(3) An indication (denoted as indication #3) for indicating a CAPC value, e.g., a CAPC indication.
(4) An indication (denoted as indication #4) for indicating a total number of resource(s) (e.g., a total number of physical slot(s)) in time domain within an LBT sensing duration. In the embodiments of the present disclosure, a LBT sensing duration may also be named as “an LBT duration”, “a sensing duration of an LBT procedure”, or the like.
(5) An indication (denoted as indication #5) for indicating a (pre-)configured mapping relationship between the CAPC value and a time length of the LBT sensing duration.
(6) An indication (denoted as indication #6) for enabling or disabling a COT sharing behaviour of a UE. Indication #6 may be named as “an SL-COT sharing enable indicator”, “a COT sharing determination indicator”, “an indicator for a COT sharing behaviour during a resource re-evaluation procedure and/or a pre-emption checking procedure”, or the like.
   (a) In some embodiments, indication #6 may be defined and included in higher layer signalling. Indication #6 may indicate a physical layer of the UE to perform operations. If indication #6 is provided and represents “enable”, a COT sharing determination step during a resource re-evaluation and/or pre-emption checking procedure is enabled. If indication #6 is provided and does not represent “enable”, the COT sharing determination step during the resource re-evaluation and/or pre-emption checking procedure is disenabled.
   (b) Indication #6 may be applicable in the embodiments of any of FIGS. 6A, 6B, 8A, 8B, 10A, 10B, 12A, and 12B as described below.

In some embodiments, in the case that information #1 is received by the UE, information #1 may be included in at least one of:
(1) At least one of SCI or a sidelink transmission received on a resource (denoted as resource #1) before the candidate resource in the time domain e.g., including at least one of indications #1 to #4. In an embodiment, the reserved resource is determined based on resource #1 and the resource reservation period (e.g., P_{rsvp_RX}) indicated by indication #1.
(2) Configuration information received from a network node (e.g., BS 120 in FIG. 1), e.g., including indication #5.
(3) Configuration information per a resource pool received from the network node, e.g., including indication #6.
(4) Indication information received from an upper layer of the UE, e.g., including indication #6.

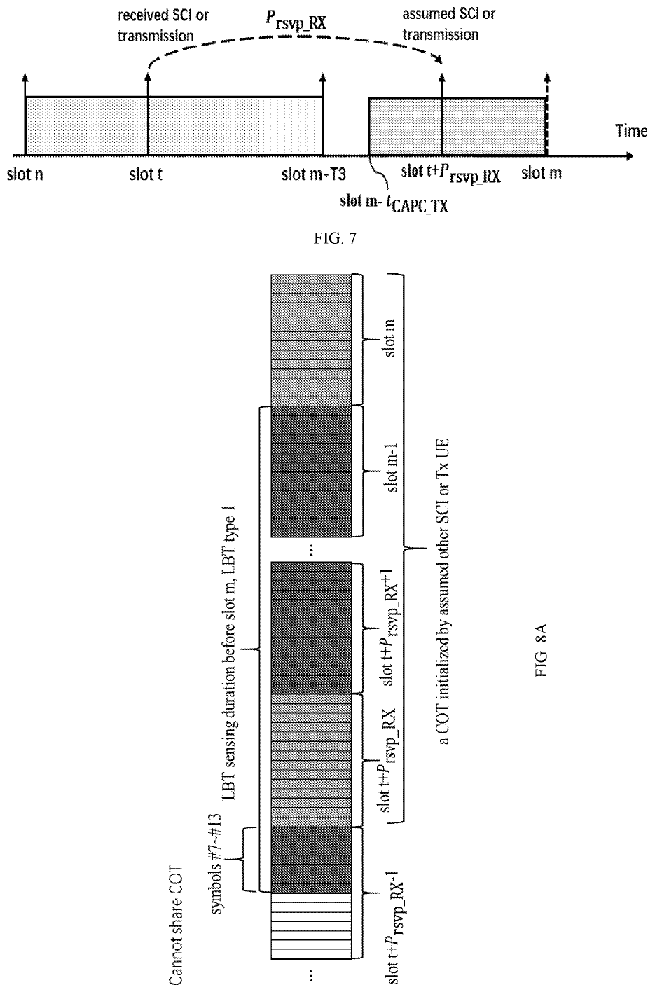

In some embodiments, the UE may perform at least one of following operations:
(1) The UE may determine a reserved resource (e.g., slot t+P_{rsvp_RX}) for an assumed sidelink transmission to be received by the UE from another UE (e.g., UE 110b in FIG. 1) based on indication #1.
(2) In response to determining that the reserved resource is after the candidate resource in the time domain, the UE may determine an LBT sensing duration (denoted as LBT sensing duration #1 for simplicity) before the reserved resource based on at least one of: indication #2, indication #3, indication #4, or indication #5. For example, a start time point of LBT sensing duration #1 may be determined as “slot t+P_{rsvp_RX}−t_{CAPC_RX}” as shown in the embodiments of FIG. 4 or FIG. 9.
(3) In response to determining that the reserved resource is before the candidate resource in the time domain, the UE may determine another LBT sensing duration (denoted as LBT sensing duration #2 for simplicity) before the candidate resource based on at least one of: indication #2, indication #3, indication #4, or indication #5. For example, a start time point of LBT sensing duration #2 may be determined as “slot m−t_{CAPC_TX}” as shown in the embodiments of FIG. 7 or “slot m+k1−t_{CAPC_TX}” as shown in the embodiments of FIG. 11.

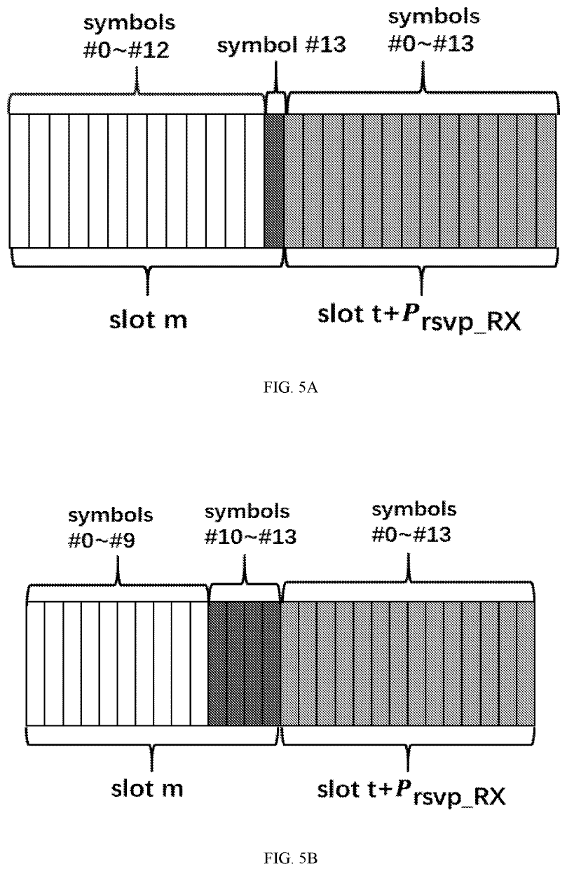

In some embodiments, to determine whether the candidate resource is available, the UE may perform at least one of following operations:
(1) The UE may determine whether a set of time-frequency resources (denoted as set #1 for simplicity) within the candidate resource overlaps with another set of time-frequency resources (denoted as set #2 for simplicity) within the reserved resource. For instance, the UE may determine that set #1 overlaps or partially overlaps with set #2, e.g., as described in the embodiments of any of FIGS. 5A and 5B.
(2) In response to determining that the reserved resource is after the candidate resource in the time domain, the UE may determine whether set #1 is located within LBT sensing duration #1 before the reserved resource. Specific examples are described in the embodiments of any of FIGS. 4-6B and 9-10B.
(3) In response to determining that the reserved resource is before the candidate resource in the time domain, the UE may determine whether set #2 is located within LBT sensing duration #2 before the candidate resource. Specific examples are described in the embodiments of any of FIGS. 7-8B and 11-12B.
(4) The UE may determine whether a priority level of the reserved resource is higher than a priority level of the candidate resource. Specific examples are described in the embodiments of any of FIGS. 9-12B.

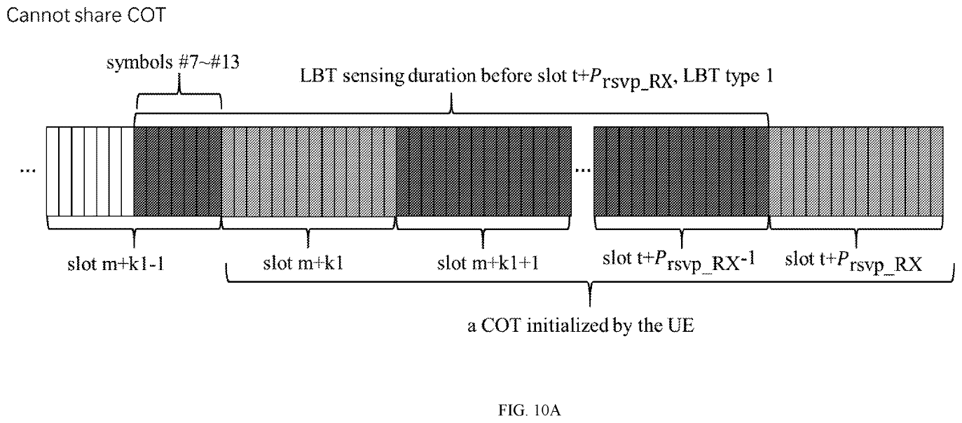

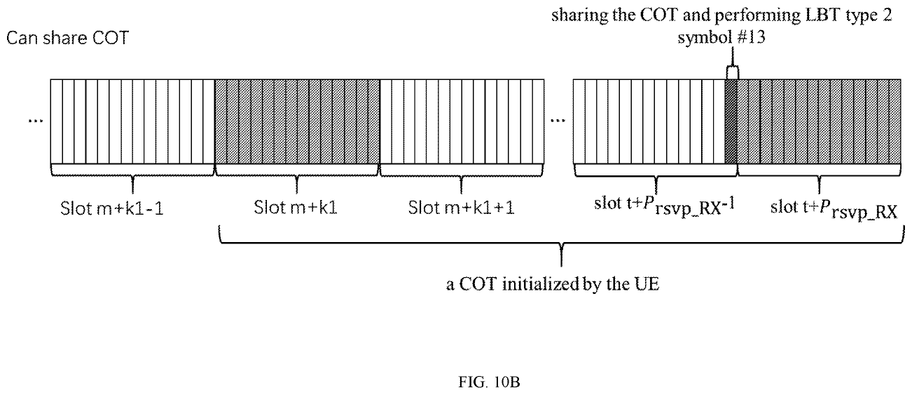

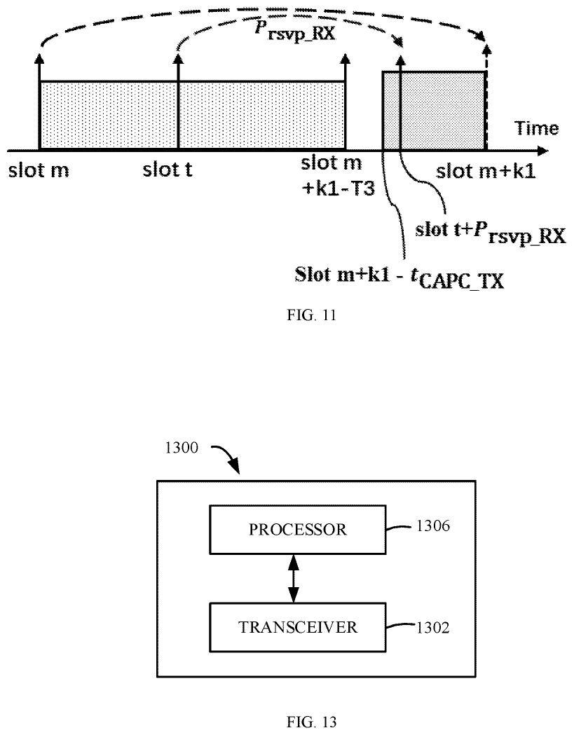

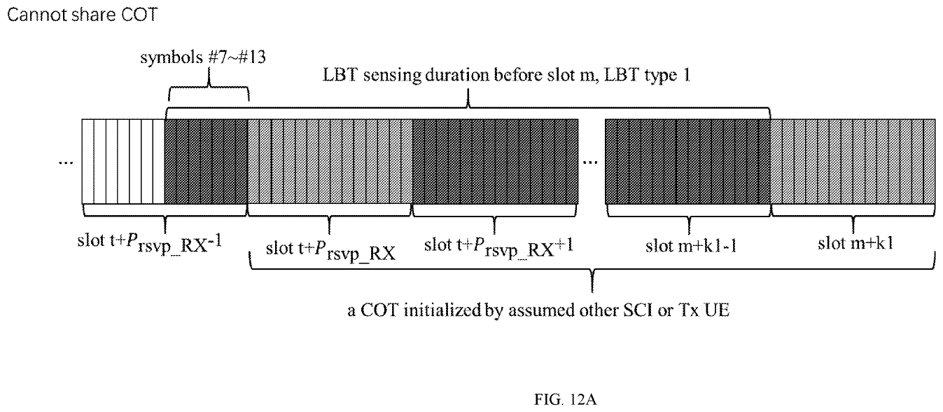

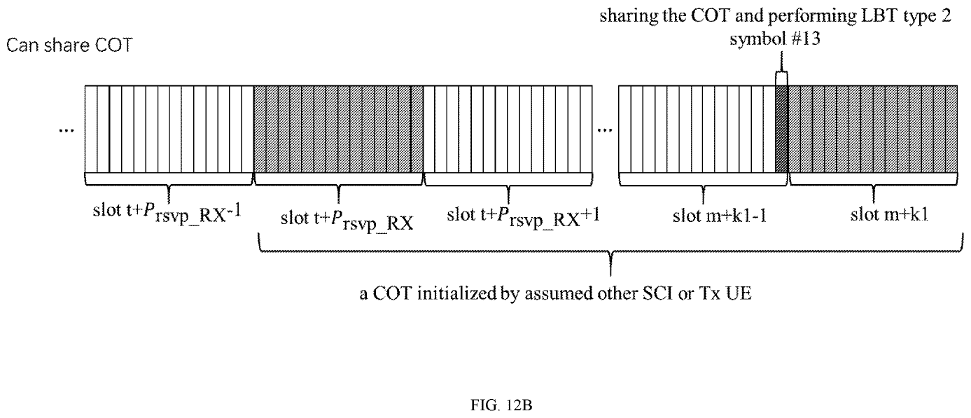

In some embodiments, the UE may determine that the candidate resource is unavailable in response to determining one of:
(1) set #1 (partially) overlaps with set #2, e.g., as described in the embodiments of any of FIGS. 4-12B;
(2) set #1 is located within LBT sensing duration #1, e.g., as described in the embodiments of any of FIGS. 4-6B;
(3) set #1 is located within LBT sensing duration #1, and the priority level of the reserved resource is higher than the priority level of the candidate resource, e.g., as described in the embodiments of any of FIGS. 9-10B;
(4) set #2 is located within LBT sensing duration #2, e.g., as described in the embodiments of any of FIGS. 7-8B; or
(5) set #2 is located within LBT sensing duration #2, and the priority level of the reserved resource is higher than the priority level of the candidate resource, e.g., as described in the embodiments of any of FIGS. 11-12B.

In some embodiments, the UE may determine that the candidate resource is available in response to determining one of:
(1) set #1 does not overlap with set #2, e.g., as described in the embodiments of any of FIGS. 4-12B;
(2) set #1 is not located within LBT sensing duration #1, e.g., as described in the embodiments of any of FIGS. 4-6B;
(3) set #1 is located within LBT sensing duration #1, and the priority level of the reserved resource is lower than the priority level of the candidate resource, e.g., as described in the embodiments of any of FIGS. 9-10B;
(4) set #2 is not located within LBT sensing duration #2, e.g., as described in the embodiments of any of FIGS. 7-8B; or
(5) set #2 is located within LBT sensing duration #2, and the priority level of the reserved resource is lower than the priority level of the candidate resource, e.g., as described in the embodiments of any of FIGS. 11-12B.

In some embodiments, in response to determining that set #1 is located within LBT sensing duration set #1, the UE may perform at least one of following operations:
(1) the UE may determine whether one or more time-frequency resources within set #1 for transmitting sidelink transmission #1 (e.g., a PSCCH and/or PSSCH transmission) overlap with LBT sensing duration #1;
(2) in response to determining that the one or more frequency time resources overlap with LBT sensing duration #1, the UE may determine that the candidate resource is unavailable; or
(3) in response to determining that the one or more frequency time resources do not overlap with LBT sensing duration #1, the UE may determine that the candidate resource is available. Specific examples are described in the embodiments of any of FIGS. 4-6B and 9-10B.

In some embodiments, in response to determining that set #1 is located within LBT sensing duration #1, the UE may perform at least one of following operations:
(1) the UE may determine whether a COT (denoted as COT #1 for simplicity) including the candidate resource initialized by the UE can be shared to the assumed sidelink transmission in the reserved resource; or
(2) in response to determining that COT #1 cannot be shared to the assumed sidelink transmission in the reserved resource, the UE may determine that the candidate resource is unavailable. Specific examples are described in the embodiments of any of FIGS. 6A, 6B, 10A, and 10B.

In an embodiment, the UE may perform following operations:
(1) the UE may determine whether indication #6 enables or disables the COT sharing behaviour of the UE; and
(2) in response to determining that indication #6 enables the COT sharing behaviour of the UE, the UE may start to determine whether COT #1 can be shared to the assumed sidelink transmission in the reserved resource.

In another embodiment, in response to determining that COT #1 can be shared to the assumed sidelink transmission in the reserved resource, the UE may perform one of following operations:
(1) the UE may determine that the candidate resource is available; or
(2) the UE may transmit, to an upper layer of the UE, at least one of a re-evaluation or pre-emption checking result for the candidate resource or information associated with COT #1. In an example, the information associated with COT #1 includes at least one of: remaining channel occupancy duration of COT #1; CAPC information of COT #1; or priority level information of COT #1. The upper layer of the UE may determine whether the candidate resource is available based on at least one of: the re-evaluation or pre-emption checking result for the candidate resource, or the information associated with COT #1.

In some embodiments, in response to determining that set #2 is located within LBT sensing duration #2, the UE may determine whether a COT (denoted as COT #2 for simplicity) including the reserved resource initialized by the another UE can be shared to sidelink transmission #1 in the candidate resource. In some other embodiments, in response to determining that COT #2 cannot be shared to sidelink transmission #1 in the candidate resource, the UE may determine that the candidate resource is unavailable. Specific examples are described in the embodiments of any of FIGS. 8A, 8B, 12A, and 12B.

In an embodiment, in response to determining that COT #2 can be shared to sidelink transmission #1 in the candidate resource, the UE may perform one of following operations:
(1) The UE may determine that the candidate resource is available.
(2) The UE may transmit, to an upper layer of the UE, at least one of a re-evaluation or pre-emption checking result for the candidate resource or information associated with COT #2. In some example, the information associated with COT #2 includes at least one of: remaining channel occupancy duration of COT #2; CAPC information of COT #2; or priority level information of COT #2. The upper layer of the UE may determine whether the candidate resource is available based on at least one of: the re-evaluation or pre-emption checking result for the candidate resource, or the information associated with COT #2.
(3) The UE may transmit, to the upper layer of the UE, a preferred type of an LBT procedure before the candidate resource performed by the UE.

It should be appreciated by persons skilled in the art that the sequence of the operations in exemplary flowchart 300 may be changed and some of the operations in exemplary flowchart 300 may be eliminated or modified, without departing from the spirit and scope of the disclosure.

In addition, some embodiments of the present disclosure provide an exemplary procedure performed by a network node (e.g., a BS). Although described with respect to a network node, it should be understood that other devices may be configured to perform a similar procedure. In this exemplary procedure, a BS (e.g., BS 120 in FIG. 1) may transmit configuration information per a resource pool to a UE. The configuration information may include at least one of:
(1) an indication for indicating a CAPC value associated with the UE, e.g., indication #3 as described above;
(2) an indication for indicating a total number of resources in a time domain within an LBT sensing duration associated with the UE, e.g., indication #4 as described above;
(3) an indication for indicating a (pre-)configured mapping relationship between the CAPC value and a time length of the LBT sensing duration, e.g., indication #5 as described above; or
(4) an indication for enabling or disabling a COT sharing behaviour of the UE, e.g., indication #6 as described above.

Details described in all other embodiments of the present application, e.g., in the embodiments of FIGS. 2A-12B are applicable for this exemplary procedure. Moreover, details described in this exemplary procedure are applicable for all the embodiments of FIGS. 1-13.

FIGS. 4, 5A, and 5B illustrate schematic diagrams of a resource re-evaluation procedure in accordance with some embodiments of the present disclosure.

In the embodiments of FIG. 4, a UE may perform a resource re-evaluation procedure similar to that described in the embodiments of FIG. 2A. After a resource in slot m is selected for a PSCCH and/or PSSCH transmission by a higher layer of the UE in slot n, the higher layer of the UE may request the UE to perform a re-evaluation procedure on a set of resources, e.g., (r₀, r₁, r₂, . . . ), within a set of candidate resources, e.g., S_{A}, at least, in slot m−T3. Then, the UE may report the resource re-evaluation result(s). The sensing duration for resource re-evaluation procedure can be between slot n and slot m−T3.

In the embodiments of FIG. 4, the UE shall exclude any candidate resource from the set of candidate resources, e.g., S_{A}, if the UE determines that the candidate resource (e.g., resource rᵢ) is unavailable. In some embodiments of FIG. 4, following operations may be performed by the UE.
(1) The UE may receive SCI and/or a sidelink transmission in slot t (i.e., “received SCI or transmission” as shown in FIG. 4).
   (a) The SCI and/or the sidelink transmission may include a resource reservation period indication (e.g., indication #1) to indicate the value P_{rsvp_RX}.
   (b) The SCI and/or the sidelink transmission may include a priority indication (e.g., indication #2) or a CAPC indication (e.g., indication #3) to indicate a length of an LBT sensing duration, e.g., t_{CAPC_RX} as shown in FIG. 4.
   (c) The SCI and/or the sidelink transmission may include an indication (e.g., indication #4) indicating a total number of slot(s) during LBT sensing, e.g., n_{CAPC_RX} (of SCI transmitting UE). For example, the slot index(es) and/or the total number of slot(s) during LBT sensing may refer to continuous physical slot(s) in the time domain.
(2) The UE may assume that another SCI or another sidelink transmission is to be received in slot t+P_{rsvp_RX} (e.g., “assumed SCI or transmission” as shown in FIG. 4).
(3) If the UE determines that frequency and/or time resource(s) in slot m from a set of resources, e.g., (r₀, r₁, r₂, . . . ) overlaps with the frequency and/or time resource(s) of assumed another SCI or another sidelink transmission in slot t+P_{rsvp_RX}, or if the UE determines that the frequency and/or time resource(s) in slot m from the set of resource (r₀, 1, 2, . . . ) overlaps with the LBT sensing duration before slot t+P_{rsvp_RX}, the UE may perform different operations in different embodiments:
   (a) In some embodiments of FIG. 4, the UE may directly exclude the candidate resource (i.e., the frequency and/or time resource(s) in slot m) from S_{A}.
   (b) In some further embodiments of FIG. 4, if the LBT procedure (sensing duration before slot t+P_{rsvp_RX}) is performed on some symbols of slot m and the sensing duration overlaps with the frequency and/or time resource(s) in slot m, slot m will be determined as (partially) overlapping, i.e., slot m may be excluded by the UE. Specific examples are described in the embodiments of any of FIGS. 5A and 5B.
   (c) In some other embodiments of FIG. 4, a COT sharing behaviour may be performed by the UE during performing a resource re-evaluation procedure to determine whether a candidate resource within a set of candidate resources for the UE is available. Specific examples are described in the embodiments of any of FIGS. 6A and 6B.

In some embodiments of FIG. 4, if the candidate resource (e.g., resource rᵢ) from the set (r₀, r₁, r₂, . . . ) is not a member of S_{A}, the UE may exclude the resource rᵢ from S_{A} and may report the re-evaluation result(s) of resource rᵢ to higher layer(s) of the UE.

In particular, as shown in FIG. 5A, if the LBT sensing duration (i.e., sensing duration before slot t+P_{rsvp_RX}) occupies one symbol (i.e., symbol #13 in slot m), and the UE's PSCCH and/or PSSCH transmission will be transmitted on symbols #0˜#12 in slot m, which does not overlap with the sensing duration, the UE may determine that slot m is available. In other words, the UE's PSCCH and/or PSSCH transmission in slot m does not (partially) overlap with the sensing duration.

As shown in FIG. 5B, if the LBT sensing duration (sensing duration before slot t+P_{rsvp_RX}) occupy four symbols (i.e., symbols #10˜#13 in slot m), but the UE's PSCCH and/or PSSCH transmission will be transmitted on symbols #0˜#12 in slot m, which overlap with the sensing duration, the UE may determine that slot m is unavailable and needs to be excluded. In other words, the UE's PSCCH and/or PSSCH transmission in slot m partially overlaps with the sensing duration.

In some embodiments of any of FIGS. 4, 5A, and 5B, the LBT sensing duration before slot t+P_{rsvp_RX} for the assumed another SCI or another sidelink transmission can be determined by the UE based on at least one of:
(1) A CAPC indication (e.g., indication #3) received in “received SCI or transmission” in slot t as shown in FIG. 4 or determined by the UE.
(2) It can be based on an indication (e.g., indication #5) indicating a (pre-)configured mapping relationship between the (received or determined) CAPC indication and the LBT sensing duration (e.g., a contention window size) per a resource pool.
(3) It is up to the UE's implementation to determine the LBT sensing duration based on the (received or determined) CAPC indication and/or the (received or determined) priority indication (e.g., indication #2).

FIGS. 6A and 6B illustrate schematic diagrams of sharing a COT during a resource re-evaluation procedure in accordance with some embodiments of the present disclosure. The embodiments of FIGS. 6A and 6B refer to specific embodiments of FIG. 4, in which a COT sharing behaviour may be performed by a UE during performing a resource re-evaluation procedure to determine whether a candidate resource within a set of candidate resources for the UE is available. FIG. 6A refers to a “cannot share COT” case. FIG. 6B refers to a “can share COT” case.

In some embodiments of FIGS. 6A and 6B, a UE may receive an SL-COT sharing enable indicator (i.e., indication #6 described above) for enabling or disabling a COT sharing behaviour of a UE. If the SL-COT sharing enable indicator enables a UE's COT sharing behaviour, a COT sharing behaviour may be performed by the UE during a resource re-evaluation procedure to determine whether a candidate resource within a set of candidate resources for the UE is available.

In the embodiments of FIG. 6A, a COT initialized by the UE occupy all symbols in slot m, slot m+1, “slot(s) between slot m+1 and slot t+P_{rsvp_RX}−1”, slot t+P_{rsvp_RX}−1, and slot t+P_{rsvp_RX}. The UE performs a LBT type 1 procedure, and the LBT sensing duration before slot t+P_{rsvp_RX} occupy symbols #7 to #13 in slot m−1 and all symbols in slot m, slot m+1, “slot(s) between slot m+1 and slot t+P_{rsvp_RX}−1”, and slot t+P_{rsvp_RX}−1. That is, the UE may determine that frequency and/or time resource(s) in slot m (e.g., marked as resource rᵢ) from a set of resources, e.g., (r₀, r₁, r₂, . . . ), overlaps with the LBT sensing duration before slot t+P_{rsvp_RX} (i.e., LBT type 1 sensing duration), i.e., the UE determines that slot m is located within the LBT sensing duration of the UE.

In the embodiments of FIG. 6A, if the UE determines that the COT initialized by the UE for a PSCCH and/or PSSCH transmission in slot m cannot be shared to the assumed another SCI or another sidelink transmission in slot t+P_{rsvp_RX}, the UE shall exclude the frequency and/or time resource(s) in slot m (e.g., resource rᵢ) from the S_{A}.

In the embodiments of FIG. 6B, the UE may initialize a COT with the same time length and perform a LBT type 1 procedure with the same LBT sensing duration before slot t+P_{rsvp_RX} as those in the embodiments of FIG. 6A. The UE may determine that frequency and/or time resource(s) in slot m (e.g., resource rᵢ) from the set of resources (r₀, r₁, r₂, . . . ) overlaps with the LBT sensing duration before slot t+P_{rsvp_RX}. In the embodiments of FIG. 6B, if the UE determines that the COT initialized by the UE for a PSCCH and/or PSSCH transmission in slot m can be shared to the assumed another SCI or another sidelink transmission in slot t+P_{rsvp_RX}, the UE shall not exclude the frequency and/or time resource(s) in slot m (e.g., resource rᵢ) from the S_{A}.

In some embodiments of FIG. 6B, since the COT can be shared, the UE may perform a LBT type 2 procedure before slot t+P_{rsvp_RX}, as shown in FIG. 6B. For example, the LBT sensing duration of the LBT type 2 procedure may occupy symbol #13 in slot t+P_{rsvp_RX}−1.

In some embodiments of FIG. 6B, the UE may additionally report re-evaluation result(s) with COT sharing information (e.g., remaining channel occupancy duration of the COT, CAPC information, and/or priority information) to higher layer(s) of the UE. It is up to the higher layer(s) of the UE or the UE's implementation to determine whether to exclude the candidate resource or not.

FIG. 7 illustrates a schematic diagram of a resource re-evaluation procedure in accordance with some embodiments of the present disclosure. In the embodiments of FIG. 7, similar to FIG. 4, a UE may perform a resource re-evaluation procedure, and slot n, slot t, slot m−T3, slot t+P_{rsvp_RX}, and slot m have the same meanings as those in FIG. 4. In particular, after a resource in slot m is selected for a PSCCH and/or PSSCH transmission by higher layer(s) of the UE (e.g., in slot n as shown in FIG. 7), the higher layer(s) of the UE may request the UE to perform a resource re-evaluation procedure on a set of resources, e.g., (r₀, r₁, r₂, . . . ), at least, in slot m−T3. Then, the UE may report resource re-evaluation result(s). The sensing duration for resource re-evaluation procedure may be between slot n and slot m−T3.

In the embodiments of FIG. 7, the UE shall exclude any candidate resource from S_{A} if the UE determines that the candidate resource (e.g., resource rᵢ) is unavailable. In some embodiments of FIG. 7, there may be following operations performed by the UE.
(1) The UE receives SCI and/or a sidelink transmission in slot t, including a resource reservation period indication to indicate the value P_{rsvp_RX}.
(2) The UE assumes another SCI or another sidelink transmission is to be received in slot t+P_{rsvp_RX}.
(3) The UE determines a length of LBT sensing duration, e.g., t_{CAPC_TX} as shown in FIG. 7, or a total number of LBT sensing slot(s), e.g., n_{CAPC_TX}, corresponding to potential PSCCH and/or PSSCH transmission(s) in slot m. For example, the slot index(es) and/or the total number of LBT sensing slot(s) may refer to continuous physical slot(s) in time domain.
(4) If the UE determines that frequency and/or time resource(s) in slot m from a set of resources, e.g., (r₀, T1, T2, . . . ) overlaps with frequency and/or time resource(s) of assumed another SCI or another sidelink transmission in slot t+P_{rsvp_RX}, or the assumed another SCI or another sidelink transmission in slot t+P_{rsvp_RX} overlaps with the LBT sensing duration before slot m, the UE may perform different operations in different embodiments:
   (a) In some embodiments of FIG. 7, the UE may directly exclude the candidate resource (i.e., the frequency and/or time resource(s) in slot m) from S_{A}.
   (b) In some further embodiments of FIG. 7, a COT sharing behaviour may be performed by another UE during the UE performs the resource re-evaluation procedure to determine whether the candidate resource for the UE is available. Specific examples are described in the embodiments of any of FIGS. 8A and 8B.

In some embodiments of FIG. 7, if the candidate resource (e.g., resource rᵢ) from the set (r₀, T1, T2, . . . ) is not a member of S_{A}, the UE may exclude the resource rᵢ from S_{A} and may report the re-evaluation result(s) of resource rᵢ to higher layer(s) of the UE.

FIGS. 8A and 8B illustrate schematic diagrams of sharing a COT during a resource re-evaluation procedure in accordance with some embodiments of the present disclosure. The embodiments of FIGS. 8A and 8B refer to specific embodiments of FIG. 7, in which a COT sharing behaviour may be performed by another UE during a UE performs a resource re-evaluation procedure to determine whether a candidate resource within a set of candidate resources for the UE is available. FIG. 8A refers to a “cannot share COT” case. FIG. 8B refers to a “can share COT” case.

In some embodiments of FIGS. 8A and 8B, another UE (i.e., other Tx UE, e.g., UE 110b in FIG. 1) may receive an SL-COT sharing enable indicator (i.e., indication #6) for enabling or disabling a COT sharing behaviour of the another UE. If the SL-COT sharing enable indicator enables the COT sharing behaviour, the another UE may perform a COT sharing behaviour during the UE (e.g., UE 110a in FIG. 1) performs the resource re-evaluation procedure to determine whether the candidate resource for the UE is available.

In the embodiments of FIG. 8A, a COT initialized by assumed other SCI (e.g., in slot t+P_{rsvp_RX}) or the assumed other Tx UE (for example, the another UE, e.g., UE 110b in FIG. 1) for a PSCCH and/or PSSCH transmission in slot t+P_{rsvp_RX} occupy all symbols in slot t+P_{rsvp_RX}, slot t+P_{rsvp_RX}+1, “slot(s) between slot t+P_{rsvp_RX}+1 and slot m−1”, slot m−1, and slot m. The UE (e.g., UE 110a in FIG. 1) performs a LBT type 1 procedure, and the LBT sensing duration before slot m occupy symbols #7 to #13 in slot t+P_{rsvp_RX}−1 and all symbols in slot t+P_{rsvp_RX}, slot t+P_{rsvp_RX}+1, “slot(s) between slot t+P_{rsvp_RX}+1 and slot m−1”, and slot m−1. That is, the UE determines that frequency and/or time resource(s) in slot t+P_{rsvp_RX} overlaps with the LBT sensing duration before slot m (e.g., a LBT type 1 sensing duration), i.e., slot t+P_{rsvp_RX} is located within the LBT sensing duration of the UE. In the embodiments of FIG. 8A, if the UE determines that the COT initialized by the assumed other SCI or Tx UE cannot be shared to a PSCCH and/or PSSCH transmission in slot m, the UE shall exclude frequency and/or time resource(s) in slot m (e.g., marked as resource rᵢ) from S_{A}.

In the embodiments of FIG. 8B, the assumed other SCI (e.g., in slot t+P_{rsvp_RX}) or the assumed other Tx UE (e.g., UE 110b in FIG. 1) may initialize a COT with the same time length and perform a LBT type 1 procedure with the same LBT sensing duration before slot m as those as shown in FIG. 8A. The UE may determine that the frequency and/or time resource(s) in slot t+P_{rsvp_RX} overlaps with the LBT sensing duration before slot m (e.g., a LBT type 1 sensing duration). In the embodiments of FIG. 8B, if the UE determines that the COT initialized by assumed other SCI or Tx UE for a PSCCH and/or PSSCH transmission in slot t+P_{rsvp_RX} can be shared to a PSCCH and/or PSSCH transmission in slot m, the UE shall not exclude the frequency and/or time resource(s) in slot m (e.g., resource rᵢ) from S_{A}.

In some embodiments of FIG. 8B, since the COT can be shared, the UE may change to perform a LBT type 2 procedure before slot m. For example, the sensing duration of the LBT type 2 procedure may occupy symbol #13 in slot m−1 as shown in FIG. 8B. In an embodiment, the UE may be indicated by higher layer(s) of the UE to perform the LBT type 2 procedure before slot m.

In some embodiments of FIG. 8B, the UE may additionally report re-evaluation result(s) with COT sharing information (e.g., remaining channel occupancy duration of the COT, CAPC information, and/or priority information) to the higher layer(s) of the UE. It is up to the higher layer(s) of the UE or the UE's implementation to determine whether to exclude the candidate resource or not.

In some other embodiments of FIG. 8B, the UE may report a preferred type of an LBT procedure before the candidate resource performed by the UE. For instance, the UE may report a LBT type (e.g., LBT type 1 or LBT type 2) to the higher layer(s) of the UE. The LBT type may implicitly represent that COT is shared or not. For example, LBT type 2 implicitly represents that COT is shared. In the “can share COT” case in FIG. 8B, the UE may suggest performing a LBT type 2 procedure before the PSCCH and/or PSSCH transmission in slot m.

FIG. 9 illustrates a schematic diagram of a pre-emption checking procedure in accordance with some embodiments of the present disclosure. In the embodiments of FIG. 9, a UE may perform a pre-emption checking procedure similar to that described in the embodiments of FIG. 2B. After a resource in slot m is selected for a PSCCH and/or PSSCH transmission by the higher layer(s) of the UE (in slot n), the higher layer(s) of the UE may request the UE to perform the pre-emption checking procedure on a set of resource, e.g.,

$$( {r}_{0}^{′} , {r}_{1}^{′} , {r}_{2}^{′} , … ) ,$$

within a set of candidate resources, e.g., S_{A}, at least, in slot m+k1−T3. Then, the UE may report pre-emption checking result(s). The sensing duration for the pre-emption checking procedure can be between slot m and slot m+k1−T3.

In the embodiments of FIG. 9, the UE shall exclude any candidate resource from S_{A}, if the UE determines that the candidate resource (e.g., resource rᵢ) is unavailable. In some embodiments of FIG. 9, following operations may be performed by the UE.
(1) The UE may receive SCI and/or a sidelink transmission in slot t.
   (a) The SCI and/or the sidelink transmission may include a resource reservation period indication (e.g., indication #1) to indicate the value P_{rsvp_RX}.
   (b) The SCI and/or the sidelink transmission may include a priority indication (e.g., indication #2) or a CAPC indication (e.g., indication #3), to indicate a length of an LBT sensing duration, e.g., t_{CAPC_RX} as shown in FIG. 9.
   (c) The SCI and/or the sidelink transmission may include an indication (e.g., indication #4) indicating a total number of slot(s) during LBT sensing, e.g., n_{CAPC_RX} (of SCI transmitting UE). For example, the slot index(es) and/or the total number of slot(s) during LBT sensing may refer to continuous physical slot(s) in the time domain.
(2) The UE may assume that another SCI or another sidelink transmission is to be received in slot t+P_{rsvp_RX}.
(3) If the UE determines that frequency and/or time resource(s) in slot m+k1 (e.g., marked as resource rᵢ) from a set of resource

$$( {r}_{0}^{′} , {r}_{1}^{′} , {r}_{2}^{′} , … )$$

overlaps with frequency and/or time resource(s) of the assumed another SCI or another sidelink transmission (e.g., in slot t+P_{rsvp_RX}) or determines that the frequency and/or time resource(s) in slot m+k1 from the set of resource

$$( {r}_{0}^{′} , {r}_{1}^{′} , {r}_{2}^{′} , … )$$

overlaps with the LBT sensing duration before slot t+P_{rsvp_RX}, and if the UE determines that the priority of the assumed another SCI or another sidelink transmission is higher than the priority of the UE's transmission in slot m+k1, the UE may perform different operations in different embodiments:
(a) In some embodiments of FIG. 9, the UE may directly exclude the candidate resource (i.e., the frequency and/or time resource(s) in slot m+k1) from S_{A}.
(b) In some further embodiments of FIG. 9, if the LBT procedure (sensing duration before slot t+P_{rsvp_RX}) is performed on some frequency and/or time resource(s) (e.g., symbols) in slot m+k1 and the sensing duration overlaps with the frequency and/or time resource(s) in slot m+k1, slot m+k1 will be determined as (partially) overlapping. Then, slot m+k1 may be excluded by the UE. Specific examples of such embodiments may refer to the embodiments of FIGS. 5A and 5B by replacing slot m in FIGS. 5A and 5B with slot m+k1.
(c) In some other embodiments of FIG. 9, a COT sharing behaviour may be performed by the UE during performing the pre-emption checking procedure to determine whether the candidate resource is available, e.g., as described in the embodiments of any of FIGS. 10A and 10B.

In some embodiments of FIG. 9, if the candidate resource (e.g., resource rᵢ) from the set (r₀, r₁, r₂, . . . ) is not a member of S_{A}, the UE may exclude the resource rᵢ from S_{A} and may report the pre-emption result(s) of resource rᵢ to higher layer(s) of the UE.

FIGS. 10A and 10B illustrate schematic diagrams of sharing a COT during a pre-emption checking procedure in accordance with some embodiments of the present disclosure. The embodiments of FIGS. 10A and 10B refer to specific embodiments of FIG. 9, in which a COT sharing behaviour may be performed by a UE during performing a pre-emption checking procedure to determine whether a candidate resource within a set of candidate resources for the UE is available. FIG. 10A refers to a “cannot share COT” case. FIG. 10B refers to a “can share COT” case.

In some embodiments of FIGS. 10A and 10B, a UE may receive an SL-COT sharing enable indicator (i.e., indication #6) for enabling or disabling a COT sharing behaviour of a UE. If the SL-COT sharing enable indicator enables a UE's COT sharing behaviour, a COT sharing behaviour may be performed by the UE during performing the pre-emption checking procedure to determine whether the candidate resource is available.

In the embodiments of FIG. 10A, a COT initialized by the UE for a PSCCH and/or PSSCH transmission in slot m+k1 occupy all symbols in slot m+k1, slot m+k1+1, “slot(s) between slot m+k1+1 and slot t+P_{rsvp_RX}−1”, slot t+P_{rsvp_RX}−1, and slot t+Prst P_{rsvp_RX}. The UE performs a LBT type 1 procedure, and the LBT sensing duration before slot t+P_{rsvp_RX} occupy symbols #7 to #13 in slot m+k1−1 and all symbols in slot m+k1, slot m+k1+1, “slot(s) between slot m+k1+1 and slot t+P_{rsvp_RX}−1”, and slot t+P_{rsvp_RX}−1. The UE may determine that frequency and/or time resource(s) in slot m+k1 (e.g., marked as resource rᵢ) from a set of resource

$$( {r}_{0}^{′} , {r}_{1}^{′} , {r}_{2}^{′} , … )$$

overlaps with the LBT sensing duration before slot t+P_{rsvp_RX} (e.g., a LBT type 1 sensing duration), i.e., slot m+k1 is located within the LBT sensing duration of the UE. In the embodiments of FIG. 10A, if the UE determines that the COT initialized by the UE cannot be shared to the assumed another SCI or another sidelink transmission in slot t+P_{rsvp_RX}, the UE shall exclude the frequency and/or time resource(s) in slot m+k1 from S_{A}.

In the embodiments of FIG. 10B, the UE may initialize a COT with the same time length and perform a LBT type 1 procedure with the same LBT sensing duration before slot t+P_{rsvp_RX} as those as shown in FIG. 10A. The UE may determine that the frequency and/or time resource(s) in slot m+k1 (e.g., which is marked as resource rᵢ) from a set of resource

$$( {r}_{0}^{′} , {r}_{1}^{′} , {r}_{2}^{′} , … )$$

overlaps with the LBT sensing duration before slot t+P_{rsvp_RX} (e.g., a LBT type 1 sensing duration). In the embodiments of FIG. 10B, if the UE determines that the COT for the PSCCH and/or PSSCH transmission in slot m+k1 can be shared to the assumed another SCI or another sidelink transmission in slot t+P_{rsvp_RX}, the UE shall not exclude the frequency and/or time resource(s) in slot m+k1 from S_{A}.

In some embodiments of FIG. 10B, the UE may additionally report pre-emption checking result(s) with COT sharing information (e.g., remaining channel occupancy duration of the COT, CAPC information, and/or priority information) to higher layer(s) of the UE. It is up to the higher layer(s) of the UE or the UE's implementation to determine whether to exclude the candidate resource or not.

FIG. 11 illustrates a schematic diagram of a pre-emption checking procedure in accordance with some embodiments of the present disclosure. Similar to FIG. 9, a UE may perform a pre-emption checking procedure in the embodiments of FIG. 11, and slot m, slot t, slot m+k1−T3, slot t+P_{rsvp_RX}, and slot m+k1 have the same meanings as those in FIG. 9. In particular, after a resource in slot m is selected for a PSCCH and/or PSSCH transmission by the higher layer(s) of the UE (e.g., in slot n not shown in FIG. 11), higher layer(s) of the UE may request the UE to perform a pre-emption checking procedure on a set of resources, e.g.,

$$( {r}_{0}^{′} , {r}_{1}^{′} , {r}_{2}^{′} , … ) ,$$

at least in slot m+k1−T3. Then, the UE may report pre-emption checking result(s). The sensing duration for the pre-emption checking procedure may be at least, between slot m and slot m+k1−T3.

In the embodiments of FIG. 11, the UE shall exclude any candidate resource from S_{A} if the UE determines that the candidate resource (e.g., resource rᵢ) is unavailable. In some embodiments of FIG. 11, following operations may be performed by the UE.
(1) The UE receives SCI and/or a sidelink transmission in slot t, including a resource reservation period indication (e.g., indication #1) to indicate the value P_{rsvp_RX}.
(2) The UE assumes another SCI or another sidelink transmission is to be received in slot t+P_{rsvp_RX}.
(3) The UE determines a length of LBT sensing duration, e.g., t_{CAPC_TX} as shown in FIG. 11, or a total number of slot(s) during LBT sensing, e.g., n_{CAPC_TX}, corresponding to the potential PSCCH and/or PSSCH transmission in slot m. The slot index(es) and/or the total number of slot(s) during LBT sensing may refer to continuous physical slot(s) in time domain.
(4) If the UE determines that frequency and/or time resource(s) in slot m+k1 from a set of resource

$$( {r}_{0}^{′} , {r}_{1}^{′} , {r}_{2}^{′} , … )$$

overlaps with frequency and/or time resource(s) of the assumed another SCI or another sidelink transmission in slot t+P_{rsvp_RX} Or determines that the assumed another SCI or another sidelink transmission in slot t+P_{rsvp_RX} overlaps with the LBT sensing duration before slot m+k1, and if the UE determines that the priority of assumed the assumed another SCI or another sidelink transmission (in slot t+P_{rsvp_RX}) is higher than the priority of the UE's transmission in slot m+k1, the UE may perform different operations in different embodiments:
(a) In some embodiments of FIG. 11, the UE may directly exclude the candidate resource (i.e., the frequency and/or time resource(s) in slot m+k1) from S_{A}.
(b) In some further embodiments of FIG. 11, a COT sharing behaviour may be performed by another UE during the UE performs the pre-emption checking procedure to determine whether the candidate resource for the UE is available. Specific examples are described in the embodiments of any of FIGS. 12A and 12B.

In some embodiments of FIG. 11, if the candidate resource (e.g., resource rᵢ) from the set (r₀, r₁, r₂, . . . ) is not a member of S_{A}, the UE may exclude the candidate resource rᵢ from S_{A} and may report the pre-emption checking result(s) of resource rᵢ to higher layer(s) of the UE.

FIGS. 12A and 12B illustrate schematic diagrams of sharing a COT during a pre-emption checking procedure in accordance with some embodiments of the present disclosure. The embodiments of FIGS. 12A and 12B refer to specific embodiments of FIG. 11, in which a COT sharing behaviour may be performed by another UE during a UE performs a pre-emption checking procedure to determine whether a candidate resource within a set of candidate resources for the UE is available. FIG. 12A refers to a “cannot share COT” case. FIG. 12B refers to a “can share COT” case.

In some embodiments of FIGS. 12A and 12B, another UE (i.e., other Tx UE, e.g., UE 110b in FIG. 1) may receive an SL-COT sharing enable indicator (i.e., indication #6) for enabling or disabling a COT sharing behaviour of the another UE. If the SL-COT sharing enable indicator enables the COT sharing behaviour, the another UE may perform a COT sharing behaviour during the UE (e.g., UE 110a in FIG. 1) performs the pre-emption checking procedure to determine whether the candidate resource for the UE is available.

In the embodiments of FIG. 12A, a COT initialized by assumed other SCI (e.g., in slot t+P_{rsvp_RX}) or the assumed other Tx UE (for example, the another UE, e.g., UE 110b in FIG. 1) for a PSCCH and/or PSSCH transmission in slot t+P_{rsvp_RX} occupy all symbols in slot t+P_{rsvp_RX}, slot t+P_{rsvp_RX}+1, “slot(s) between slot t+P_{rsvp_RX}+1 and slot m+k1−1”, slot m+k1−1, and slot m+k1. The UE (e.g., UE 110a in FIG. 1) performs a LBT type 1 procedure, and the LBT sensing duration before slot m occupy symbols #7 to #13 in slot t+P_{rsvp_RX}−1 and all symbols in slot t+P_{rsvp_RX}, slot t+P_{rsvp_RX}+1, “slot(s) between slot t+P_{rsvp_RX}+1 and slot m+k1−1”, and slot m+k1−1. The UE may determine that frequency and/or time resource(s) in slot t+P_{rsvp_RX} overlaps with the LBT sensing duration before slot m+k1 (e.g., a LBT type 1 sensing duration), i.e., slot t+P_{rsvp_RX} is located within the LBT sensing duration of the UE. In the embodiments of FIG. 12A, if the UE determines that the COT initialized by the assumed other SCI or Tx UE cannot be shared to a PSCCH and/or PSSCH transmission in slot m+k1, the UE shall exclude frequency and/or time resource(s) in slot m+k1 (e.g., marked as resource rᵢ) from S_{A}.

In the embodiments of FIG. 12B, the assumed other SCI (e.g., in slot t+P_{rsvp_RX}) or the assumed other Tx UE (e.g., UE 110b in FIG. 1) may initialize a COT with the same time length and perform a LBT type 1 procedure with the same LBT sensing duration before slot m as those as shown in FIG. 12A. The UE may determine that the frequency and/or time resource(s) in slot t+P_{rsvp_RX} overlaps with the LBT sensing duration before slot m+k1 (e.g., a LBT type 1 sensing duration). In the embodiments of FIG. 12B, if the UE determines that the COT initialized by assumed other SCI or Tx UE for a PSCCH and/or PSSCH transmission in slot t+P_{rsvp_RX} can be shared to a PSCCH and/or PSSCH transmission in slot m+k1, the UE shall not exclude the frequency and/or time resource(s) in slot m+k1 (e.g., resource rᵢ) from S_{A}.

In some embodiments of FIG. 12B, since the COT can be shared, the UE may change to perform a LBT type 2 procedure before slot m+k1. For example, the sensing duration of the LBT type 2 procedure may occupy symbol #13 in slot m+k1−1 as shown in FIG. 12B. In an embodiment, the UE may be indicated by higher layer(s) of the UE to perform the LBT type 2 procedure before slot m+k1.

In some embodiments of FIG. 12B, the UE may additionally report pre-emption checking result(s) with COT sharing information (e.g., remaining channel occupancy duration of the COT, CAPC information, and/or priority information) to the higher layer(s) of the UE. It is up to the higher layer(s) of the UE or the UE's implementation to determine whether to exclude the candidate resource or not.

In some other embodiments of FIG. 12B, the UE may report a preferred type of an LBT procedure before the candidate resource performed by the UE. For instance, the UE may report a LBT type (e.g., LBT type 1 or LBT type 2) to the higher layer(s) of the UE. The LBT type may implicitly represent that COT is shared or not. For example, LBT type 2 implicitly represents that COT is shared. In the “can share COT” case in FIG. 12B, the UE may suggest performing a LBT type 2 procedure before the PSCCH and/or PSSCH transmission in slot m+k1.

FIG. 13 illustrates a block diagram of an exemplary apparatus 1300 in accordance with some embodiments of the present disclosure. As shown in FIG. 13, the apparatus 1300 may include at least one processor 1306 and at least one transceiver 1302 coupled to the processor 1306. The apparatus 1300 may be a UE or a network node (e.g., a BS).

Although in this figure, elements such as the at least one transceiver 1302 and processor 1306 are described in the singular, the plural is contemplated unless a limitation to the singular is explicitly stated. In some embodiments of the present application, the transceiver 1302 may be divided into two devices, such as a receiving circuitry and a transmitting circuitry. In some embodiments of the present application, the apparatus 1300 may further include an input device, a memory, and/or other components.

In some embodiments of the present application, the apparatus 1300 may be a UE or a network node (e.g., a BS). The transceiver 1302 and the processor 1306 may interact with each other so as to perform the operations with respect to the UEs or the network nodes described above, for example, in FIGS. 1-12B.

In some embodiments of the present application, the apparatus 1300 may further include at least one non-transitory computer-readable medium. For example, in some embodiments of the present disclosure, the non-transitory computer-readable medium may have stored thereon computer-executable instructions to cause the processor 1306 to implement the method with respect to the UEs as described above. For example, the computer-executable instructions, when executed, cause the processor 1306 interacting with transceiver 1302 to perform the operations with respect to the UEs described in FIGS. 1-12B.

For example, in some embodiments of the present disclosure, the non-transitory computer-readable medium may have stored thereon computer-executable instructions to cause the processor 1306 to implement the method with respect to the network nodes as described above. For example, the computer-executable instructions, when executed, cause the processor 1306 interacting with transceiver 1302 to perform the operations with respect to the network nodes described in FIGS. 1-12B.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
perform a resource re-evaluation procedure or a pre-emption checking procedure to determine whether a candidate resource within a set of candidate resources for the UE is available, wherein the candidate resource is selected or reserved by the UE for a first sidelink transmission on an unlicensed spectrum; and
in response to determining that the candidate resource is unavailable, exclude the candidate resource from the set of candidate resources.

2. The UE of claim 1, wherein the at least one processor is configured to cause the UE to receive first information or determine the first information, wherein the first information includes at least one of:
a first indication for indicating a resource reservation period;
a second indication for indicating a priority level;
a third indication for indicating a channel access priority class (CAPC) value;
a fourth indication for indicating a total number of resources in a time domain within a listen-before-talk (LBT) sensing duration;
a fifth indication for indicating a mapping relationship between the CAPC value and a time length of the LBT sensing duration; or
a sixth indication for enabling or disabling a channel occupancy time (COT) sharing behavior of the UE.

3. The UE of claim 2, wherein the first information is included in at least one of:
at least one of sidelink control information (SCI) or a second sidelink transmission received on a first resource before the candidate resource in the time domain;
configuration information received from a network node;
configuration information per a resource pool received from the network node; or
indication information received from an upper layer of the UE.

4. The UE of claim 3, wherein the at least one processor is configured to cause the UE to perform at least one of:
determine a reserved resource for an assumed sidelink transmission to be received by the UE from a second UE based at least in part on the first indication;
in response to a determination that the reserved resource is after the candidate resource in the time domain, determine a first LBT sensing duration before the reserved resource based at least in part on at least one of: the second indication, the third indication, the fourth indication, or the fifth indication; or
in response to a determination that the reserved resource is before the candidate resource in the time domain, determine a second LBT sensing duration before the candidate resource based at least in part on at least one of: the second indication, the third indication, the fourth indication, or the fifth indication.

5. The UE of claim 4, wherein, to determine whether the candidate resource is available, the at least one processor is configured to cause the UE to perform at least one of:
determine whether a first set of time-frequency resources within the candidate resource overlaps with a second set of time-frequency resources within the reserved resource;
in response to the determination that the reserved resource is after the candidate resource in the time domain, determine whether the first set is located within the first LBT sensing duration before the reserved resource;
in response to the determination that the reserved resource is before the candidate resource in the time domain, determine whether the second set is located within the second LBT sensing duration before the candidate resource; or
determine whether a priority level of the reserved resource is higher than a priority level of the candidate resource.

6. The UE of claim 5, wherein the at least one processor is configured to cause the UE to determine that the candidate resource is unavailable in response to a determination of one of:
the first set overlaps with the second set;
the first set is located within the first LBT sensing duration;
the first set is located within the first LBT sensing duration, and the priority level of the reserved resource is higher than the priority level of the candidate resource;
the second set is located within the second LBT sensing duration; or
the second set is located within the second LBT sensing duration, and the priority level of the reserved resource is higher than the priority level of the candidate resource.

7. The UE of claim 5, wherein, in response to the determination that the first set is located within the first LBT sensing duration, the at least one processor is configured to cause the UE to:
determine whether one or more time-frequency resources within the first set of time-frequency resources overlap with the first LBT sensing duration;
in response to a determination that the one or more time-frequency resources overlap with the first LBT sensing duration, determine that the candidate resource is unavailable; or
in response to a determination that the one or more time-frequency resources do not overlap with the first LBT sensing duration, determine that the candidate resource is available.

8. The UE of claim 5, wherein, in response to the determination that the first set is located within the first LBT sensing duration, the at least one processor is configured to cause the UE to:
determine whether a first COT including the candidate resource initialized by the UE can be shared to the assumed sidelink transmission in the reserved resource; or
in response to determining that the first COT cannot be shared to the assumed sidelink transmission in the reserved resource, determine that the candidate resource is unavailable.

9. The UE of claim 8, wherein the at least one processor is configured to cause the UE to:
determine whether the sixth indication enables or disables the COT sharing behavior of the UE; and
in response to a determination that the sixth indication enables the COT sharing behavior of the UE, start to determine whether the first COT can be shared to the assumed sidelink transmission in the reserved resource.

10. The UE of claim 8, wherein, in response to a determination that the first COT can be shared to the assumed sidelink transmission in the reserved resource, the at least one processor is configured to cause the UE:
determine that the candidate resource is available; or
transmit, to an upper layer of the UE, at least one of a re-evaluation or pre-emption checking result for the candidate resource or information associated with the first COT, wherein the upper layer of the UE is configured to determine whether the candidate resource is available based at least in part on the at least one of the re-evaluation or pre-emption checking result for the candidate resource or the information associated with the first COT.

11. The UE of claim 10, wherein the information associated with the first COT includes at least one of:
remaining channel occupancy duration of the first COT;
CAPC information of the first COT; or
priority level information of the first COT.

12. The UE of claim 5, wherein, in response to a determination that the second set is located within the second LBT sensing duration, the at least one processor is configured to cause the UE to:
determine whether a second COT including the reserved resource initialized by the second UE can be shared to the first sidelink transmission in the candidate resource; or
in response to a determination that the second COT cannot be shared to the first sidelink transmission in the candidate resource, determine that the candidate resource is unavailable.

13. The UE of claim 12, wherein, in response to a determination that the second COT can be shared to the first sidelink transmission in the candidate resource, the at least one processor is configured to cause the UE:
determine that the candidate resource is available;
transmit, to the upper layer of the UE, at least one of a re-evaluation or pre-emption checking result for the candidate resource or information associated with the second COT, wherein the upper layer of the UE is configured to determine whether the candidate resource is available based at least in part on the at least one of the re-evaluation or pre-emption checking result for the candidate resource or the information associated with the second COT; or
transmit, to the upper layer of the UE, a preferred type of an LBT procedure before the candidate resource performed by the UE.

14. A network node for wireless communication, comprising:
at least one memory; and
at least one processor coupled with the at least one memory and configured to:
transmit configuration information per a resource pool to a user equipment (UE), wherein the configuration information includes at least one of:
an indication of a channel access priority class (CAPC) value associated with the UE;
an indication of a total number of resources in a time domain within a listen-before-talk (LBT) sensing duration associated with the UE;
an indication of a mapping relationship between the CAPC value and a time length of the LBT sensing duration; or
an indication for enabling or disabling a channel occupancy time (COT) sharing behavior of the UE.

15. (canceled)

16. A method performed by a user equipment (UE), the method comprising:
performing a resource re-evaluation procedure or a pre-emption checking procedure to determine whether a candidate resource within a set of candidate resources for the UE is available, wherein the candidate resource is selected or reserved by the UE for a first sidelink transmission on an unlicensed spectrum; and
in response to determining that the candidate resource is unavailable, excluding the candidate resource from the set of candidate resources.

17. The method of claim 16, further comprising:
receiving first information or determining the first information, wherein the first information includes at least one of a first indication for indicating a resource reservation period, a second indication for indicating a priority level, a third indication for indicating a channel access priority class (CAPC) value, a fourth indication for indicating a total number of resources in a time domain within a listen-before-talk (LBT) sensing duration, a fifth indication for indicating a mapping relationship between the CAPC value and a time length of the LBT sensing duration, or a sixth indication for enabling or disabling a channel occupancy time (COT) sharing behavior of the UE;
determining a reserved resource for an assumed sidelink transmission to be received by the UE from a second UE based at least in part on the first indication;
in response to determining that the reserved resource is after the candidate resource in the time domain, determining a first LBT sensing duration before the reserved resource based at least in part on at least one of: the second indication, the third indication, the fourth indication, or the fifth indication; or
in response to determining that the reserved resource is before the candidate resource in the time domain, determining a second LBT sensing duration before the candidate resource based at least in part on at least one of: the second indication, the third indication, the fourth indication, or the fifth indication.

18. A processor for wireless communication, comprising:
at least one controller coupled with at least one memory and configured to cause the processor to:
perform a resource re-evaluation procedure or a pre-emption checking procedure to determine whether a candidate resource within a set of candidate resources for a user equipment (UE) that includes the processor is available, wherein the candidate resource is selected or reserved by the UE for a first sidelink transmission on an unlicensed spectrum; and
in response to determining that the candidate resource is unavailable, exclude the candidate resource from the set of candidate resources.

19. The processor of claim 18, wherein the at least one controller is configured to cause the processor to receive first information or determine the first information, wherein the first information includes at least one of a first indication for indicating a resource reservation period, a second indication for indicating a priority level, a third indication for indicating a channel access priority class (CAPC) value, a fourth indication for indicating a total number of resources in a time domain within a listen-before-talk (LBT) sensing duration, a fifth indication for indicating a mapping relationship between the CAPC value and a time length of the LBT sensing duration, or a sixth indication for enabling or disabling a channel occupancy time (COT) sharing behavior of the UE, wherein the first information is included in at least one of at least one of sidelink control information (SCI) or a second sidelink transmission received on a first resource before the candidate resource in the time domain, configuration information received from a network node, configuration information per a resource pool received from the network node, or indication information received from an upper layer of the UE.

20. The processor of claim 19, wherein the at least one controller is configured to cause the processor to perform at least one of:
determine a reserved resource for an assumed sidelink transmission to be received by the UE from a second UE based at least in part on the first indication;
in response to a determination that the reserved resource is after the candidate resource in the time domain, determine a first LBT sensing duration before the reserved resource based at least in part on at least one of: the second indication, the third indication, the fourth indication, or the fifth indication; or
in response to a determination that the reserved resource is before the candidate resource in the time domain, determine a second LBT sensing duration before the candidate resource based at least in part on at least one of: the second indication, the third indication, the fourth indication, or the fifth indication.

21. The processor of claim 20, wherein, to determine whether the candidate resource is available, the at least one controller is configured to cause the processor to perform at least one of:
determine whether a first set of time-frequency resources within the candidate resource overlaps with a second set of time-frequency resources within the reserved resource;
in response to the determination that the reserved resource is after the candidate resource in the time domain, determine whether the first set is located within the first LBT sensing duration before the reserved resource;
in response to the determination that the reserved resource is before the candidate resource in the time domain, determine whether the second set is located within the second LBT sensing duration before the candidate resource; or
determine whether a priority level of the reserved resource is higher than a priority level of the candidate resource.
